(19) United States
(12) Patent Application Publication
(10) Pub. No.: US 2007/0168250 A1
(43) Pub. Date: Jul. 19, 2007

(54) Method of merging art production and prepress

(76) Inventors: Gary Rellar, Cincinnati, OH (US); Kenneth W. Rellar, Cincinnati, OH (US); Jennifer Thompson, Fort Thomas, KY (US)

Correspondence Address: FROST BROWN TODD, LLC, 2200 PNC CENTER, 201 E. FIFTH STREET, CINCINNATI, OH, 45202, US

(21) Appl. No.: 11/334,589

(22) Filed: Jan. 18, 2006

(51) Int. Cl. G06Q 30/00

(52) U.S. Cl. 705/14

(57) ABSTRACT

A web-based, interactive tool provides a method of linking marketing strategies to field sales and marketing. In particular, the web-based tool allows the coordination of marketing and promotional schedules, preferred design work and pricing information, among other things, to allow substantially on-demand printing of marketing and promotional materials. The web-based tool of the present invention further provides reporting capabilities regarding the production, costs, etc. regarding the promotional materials.

### BACKGROUND OF THE INVENTION

The present invention relates to a method of merging art production and prepress for marketing and promotional materials. It further provides a mechanism for customer specific reporting on various aspects of a company's marketing/advertising project. In particular, it provides a method of streamlining marketing efforts, particularly by providing an automated, web-based method for linking marketing strategies to field sales and retail marketing, and an automated system for accomplishing the same.

Companies seek a corporate approach to align or streamline all areas of their corporate/brand/product marketing for field sales and cross-marketing opportunities. These companies, particularly those which run significant and sophisticated marketing campaigns aimed at various markets, such as retail, consumer, and/or professional markets, often share the same concerns regarding, among other things, budget and consistency of message. Among these concerns is how to provide accurate creative product to marketing segments and how to effectively communicate with them. At the same time, these companies would prefer to lower their creative agency costs but not lose corporate identity and quality design. They are also looking to quickly communicate and share creative product for new product initiatives and launch materials as well as share new product packaging and upgraded packaging to ensure accurate sales presentations. In addition, the companies would like to provide quality printed samples to their field sales forces in a cost effective and timely manner. They would like to include their customers in marketing efforts to increase awareness of new product initiatives and to promote new retail locations. Finally, they would like to obtain information regarding the results of the marketing efforts, including production costs and usage of promotional materials.

A common prior art marketing strategy is set forth in FIG. 1. FIG. 1 shows a typical linear marketing strategy where each step of the process (for example, R&D/testing, retail marketing, professional marketing, or consumer marketing) requires input from the creative agency, separate printing and generation of samples, and distribution of the final marketing materials. In this prior art process, the marketing/sales function(s) create new print jobs. The ad agency/creative function(s) design new art for each print job. The printer prints each new order, which is then warehoused until it is shipped. Portions of the print job are then shipped, as requested, and any unused, outdated materials are discarded. The process may be repeated for each step of the process (e.g., R&D/testing, retail marketing, professional marketing, or consumer marketing)

For a large company with many products and numerous marketing initiatives, managing this linear process can be cumbersome and expensive, resulting in waste of effort, time, and unused materials. This prior art process can be particularly problematic because many of these initiatives are time sensitive.

The present invention allows each function to complete its step and to modify the art work/printed product as necessary via the internet. At each step in the process, only those materials that are immediately needed are printed—eliminating warehousing of extra materials.

The present invention fills a need, particularly among smaller regional or departmental teams, for a web-based application that produces design agency-like resources at a highly efficient price. The present invention provides a simple-to-use print on demand program that gives clients (also called customers) access to professionally designed and printed marketing collateral. The method and system of the present invention allows the client to create artwork that correctly utilizes product messaging, product character, selling copy, taglines, colors, fonts, logos and imagery with negotiated usage rights. Furthermore, the tool can be valuable to clients that do not have (or do not wish to expend) sufficient funding to hire design agencies to create collateral items for use with retailer promotions. Clients are able to design or customize materials for use for their retail customers. The print ready data can also be sent to the client's preferred printing vendor for shipment directly to customers.

The method of the present invention offers several benefits to both the client and the product lines. This invention ensures the consistent use of product messaging and visualization by having professionally designed collateral with legally and regulatory approved artwork available. Reporting is also available to track quantity of printed materials, production status, distribution, and unit cost of printed materials per user or regional managers. The user also sees a cost savings by printing only the materials that teams want, and there is no cost to store the materials and no scrap cost for unused materials. There is also a savings on design agency spending because the user can design or change existing artwork on-line. The method of the present invention facilitates electronic communication with the field via email and webinars, for example. Corporate can provide the regional teams with funding to cover the cost of printing and shipment of materials. This funding allows corporate to control costs, in part by allowing the teams to print only the materials they would actually use through the print on-demand system saving the cost of printing unwanted materials, storage costs and scrap costs. The client also has the ability to “turn off” the availability of promotional materials when funding is exhausted. In addition to cost savings, this offers significant time savings for the client. The present invention allows ordering 24 hours per day, seven days per week, and materials can be shipped directly to the destinations for quick promotion execution. Finally, the present invention can cost-effectively and quickly create samples of marketing materials for use in sales promotions at the customers

### BRIEF DESCRIPTION OF THE DRAWINGS

FIG. 1 is a schematic of the prior art method of preparing art work.

FIG. 2 is a schematic of an embodiment of the method of the present invention.

FIG. 3 is a schematic of the sources of input on a web-based database used in an embodiment of the present invention.

FIG. 4 is a schematic of two aspects of the present invention.

FIGS. 5-10 are exemplary web pages for use in the present invention.

FIGS. 11-14 are exemplary reports generated in the present invention.

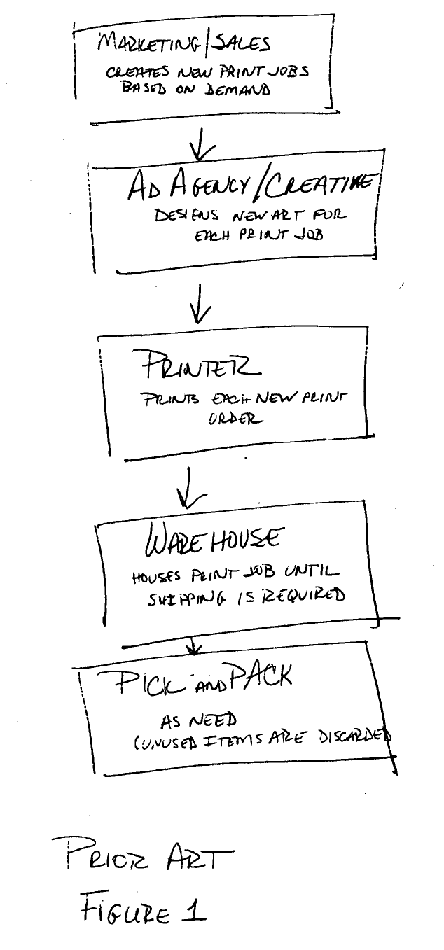

### DETAILED DESCRIPTION OF THE INVENTION

The present invention provides a way to automate services for customers or users of promotional and marketing materials through the internet and secured websites. It permits almost “on-demand” printing of only those marketing and promotional materials that are immediately needed. It also provides substantially real-time reporting on various aspects of production, costs, and usage of materials, providing key learning data and metrics.

The basis of the process is to provide an online tool that allows users to manage their printed marketing/promotional materials. A user accesses a website that provides, in one place, the information necessary to create the desired marketing and promotional materials. This information can include approved art work, customer specifications and requirements, product pricing information, etc. The approved art work may comprise logos in approved or preferred formats, art work specific to a promotion or a product, and preferred or approved colors, typeset, etc. associated with a product. This approved art work ensures brand identity and uniformity. Customer specifications and requirements can include information regarding store layout, end cap requirements, sizing necessitated by shelving units, individual store or corporate specifications regarding promotional materials, etc. With this information, the user ensures that the promotional materials will meet individual stores needs and requirements. It is also important that the user have timely pricing information. For example, if there is a promotion for a particular product that includes a $1.00 off coupon applicable for certain months of the year, it is important that the promotional materials reflect the correct coupon (and its correct value) during the correct months.

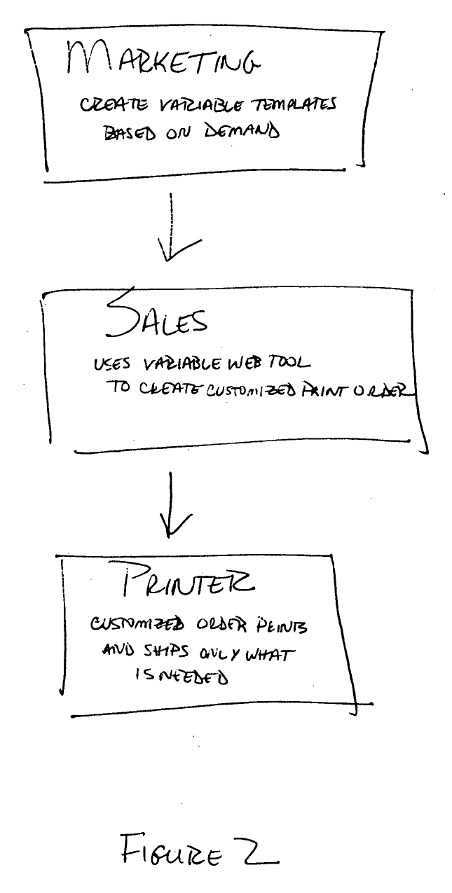

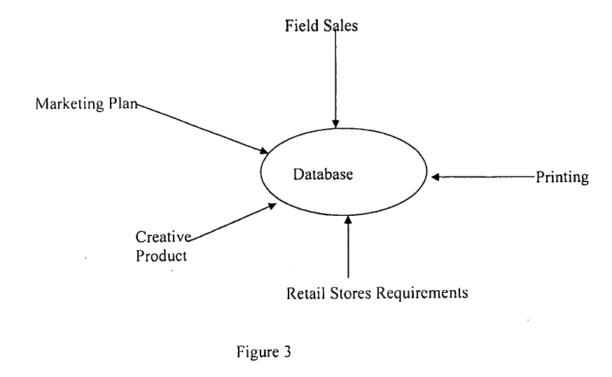

The method of the present invention provides a way, through web-enabled tools, to link marketing strategies and messaging to the final printed output. In other words, it links marketing strategies to field sales and retail marketing and, ultimately, connects all of that information to the printed output. An embodiment of the present invention is depicted in FIG. 2. As shown in FIG. 2, after the development of marketing strategies, logistical planning, and design by the creative agencies, the design products can be tied, preferably through a web-based system, to a means for selecting the appropriate image, the appropriate promotion, coupons, etc. at the appropriate time. Such means might include, for example, a marketing calendar that identifies the various promotions throughout the calendar year. A link from the calendar to the appropriate advertising materials for that time period and promotion then provides easy, accurate, and inexpensive access to creative product.

The method and system of the present invention provides an online management tool. Users will be able to customize their online tool—the screens where they actually input their marketing driver information, such as a promotional calendar. The system is flexible enough that it can be customized to each user to allow collection and transfer of the necessary information to provide automated control of promotions from marketing through to the printed output. Each user is able to create a tool that best suits its needs.

All information is then housed in a central database where it can be extracted by any approved individual user. Individual users will be granted privileges allowing them to view, order, or print from different areas of the site. Prospective individual users include: agency professionals, brand teams, marketing teams, sales teams, and possibly retailers and their marketing teams.

The method of the present invention allows segment marketing to be linked to corporate marketing strategies, including both new initiatives and maintenance marketing. Through use of the invention of the method of the present invention, creative teams are encouraged to consider downstream marketing when presenting an overall communications strategy. The web-enabled tools allow the marketing department to start, stop, and communicate promotional timeframes for new product initiatives and launch materials. In addition, sales tools are available for customization by retailer, price, and any other variable area directed by the respective marketing department. All promotional materials can be available for final delivery and can be guaranteed to be high quality off-set prints, including customized items. The web-based materials can include custom areas that may include retailer logos, location, customized contact numbers, etc. Version marketing or one-to-one marketing options can be provided to the customers, all with the benefit of off-set, quality printing.

The web-based database also allows substantially real time reporting. Reports can be generated by the customer or user on various aspects of production, costs and usage, among other things. This reporting allows enhancements or changes to be made to a program while the program is in progress, which provides cost control and can increase profitability. The brands can set promotional budgets at the launch of a promotion thus controlling expenses. With substantially real-time reporting, budgets can be updated and, for instance, can grow as a promotion program is found to be succeeding. Conversely, budgets can be reduced or a promotional program terminated if it is determined not to be a success.

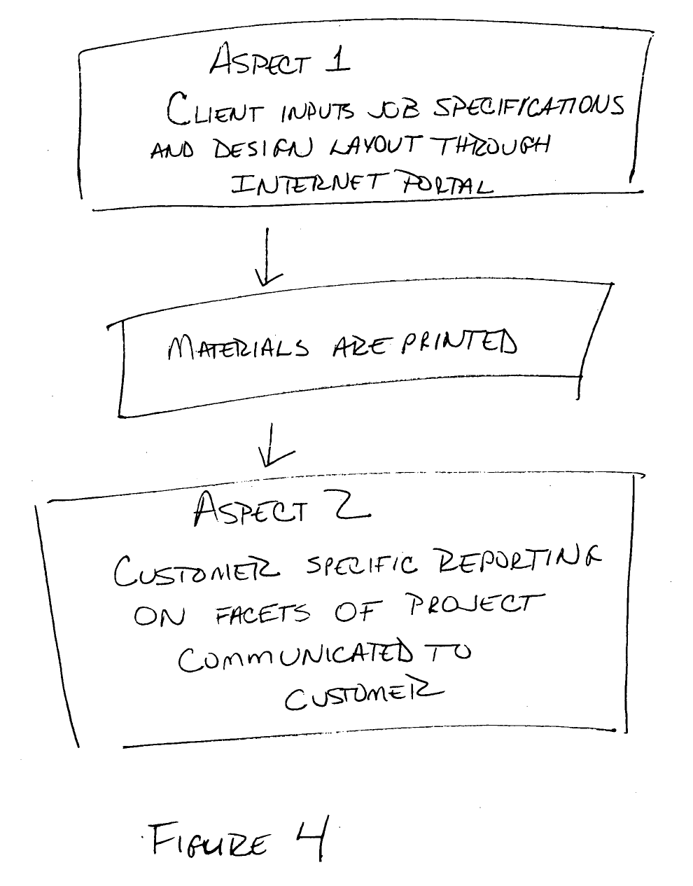

Broadly speaking the present invention can include two aspects, set forth in FIG. 4. In aspect 1, a client inputs job specifications and design layout through an internet portal. Based on that information, promotional materials are printed. In aspect 2, Customer specific reporting on facets of the project is communicated to the client. Aspect 1 may be used with or without the reporting features of aspect 2. Each of these aspects will be described in greater detail below.

Customers have traditionally communicated through printer representatives to accomplish the following “front end” tasks:
Project alignment, which provides an overview of the project/launch objectives.
Design brief, which provides the overall concept and/or art changes to existing artwork.
Project mechanical specifications, which include the size, quantity, paper, colors, etc.
Proofing, which is typically accomplished by multiple exchanges of proofs to accomplish the final art.
Production schedules, which includes the concept, proofs, and distribution due dates.

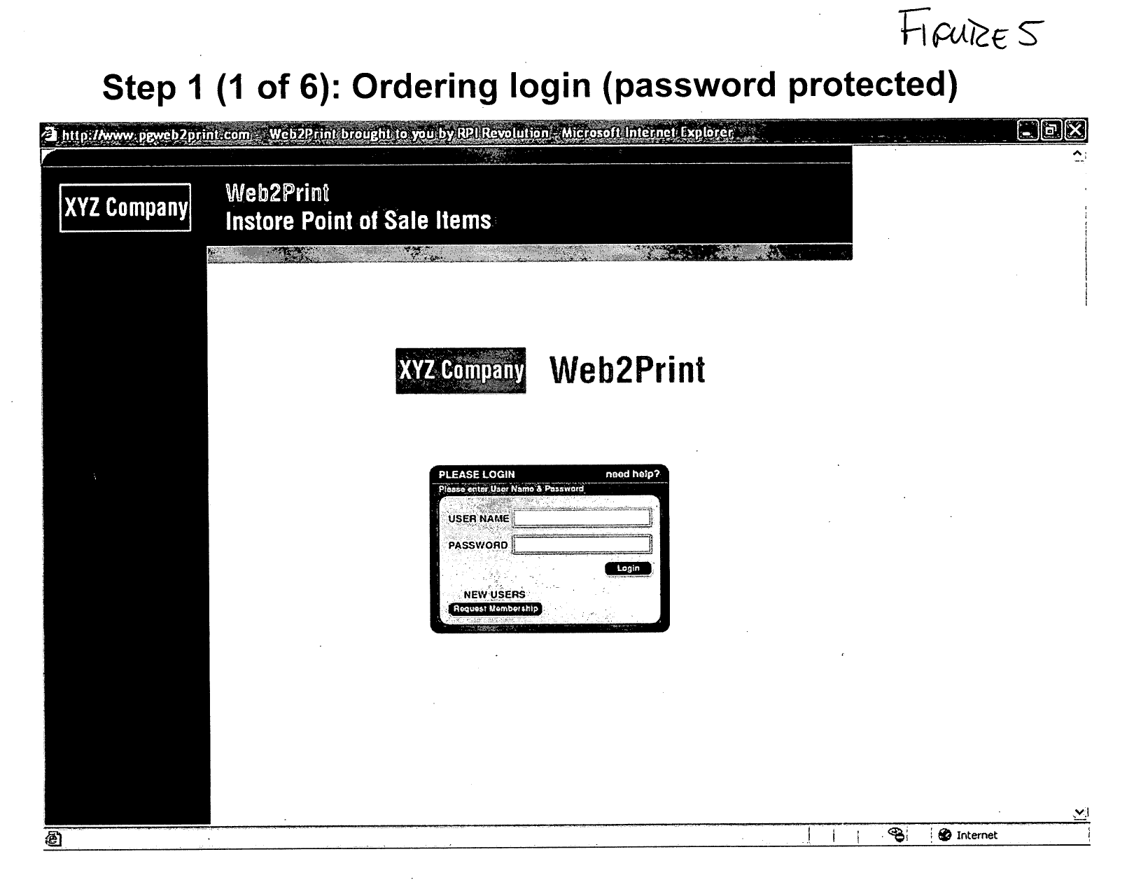

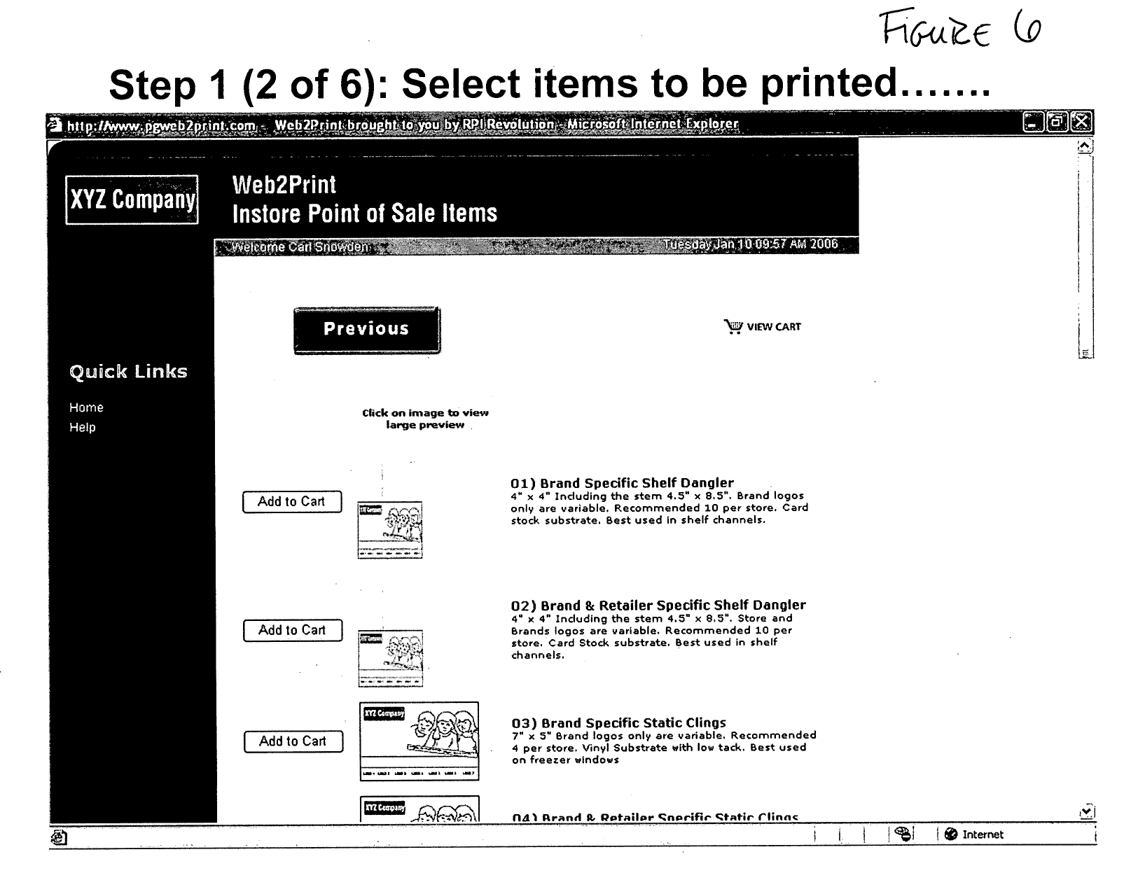

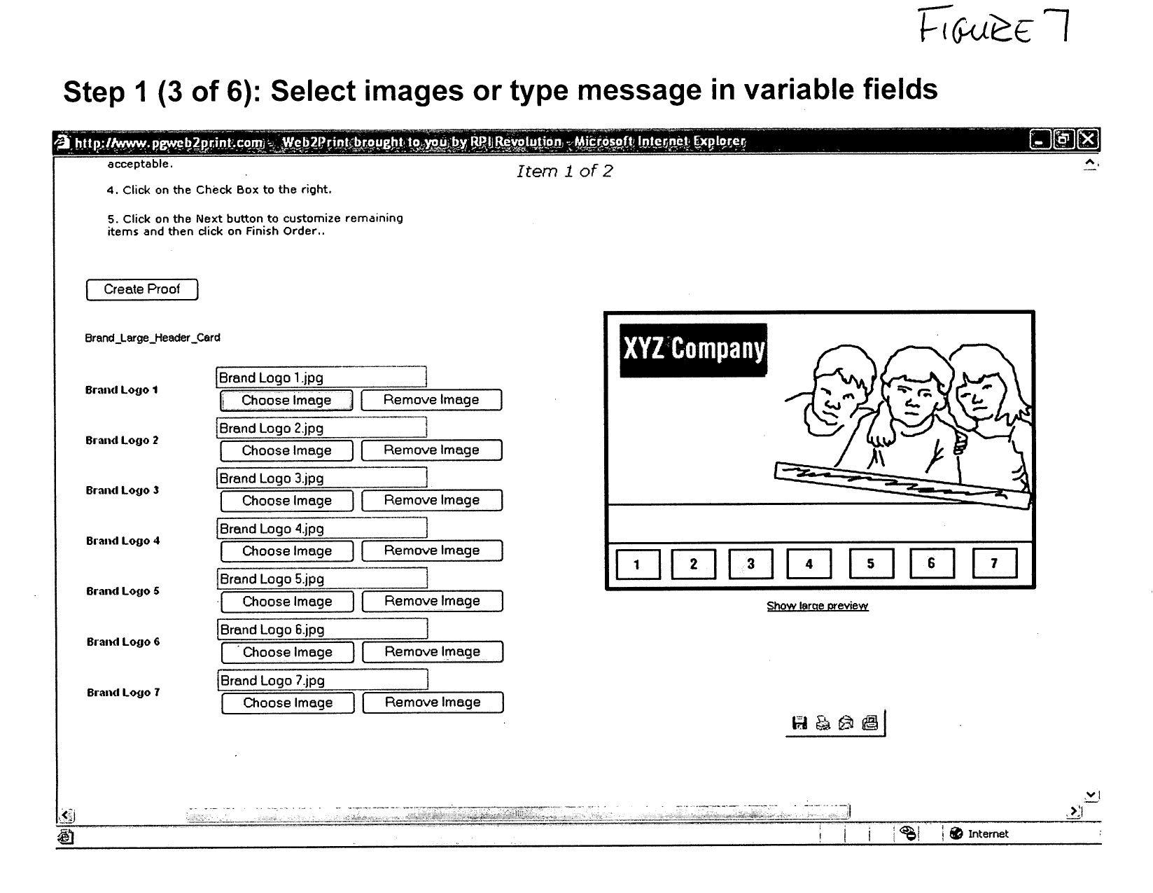

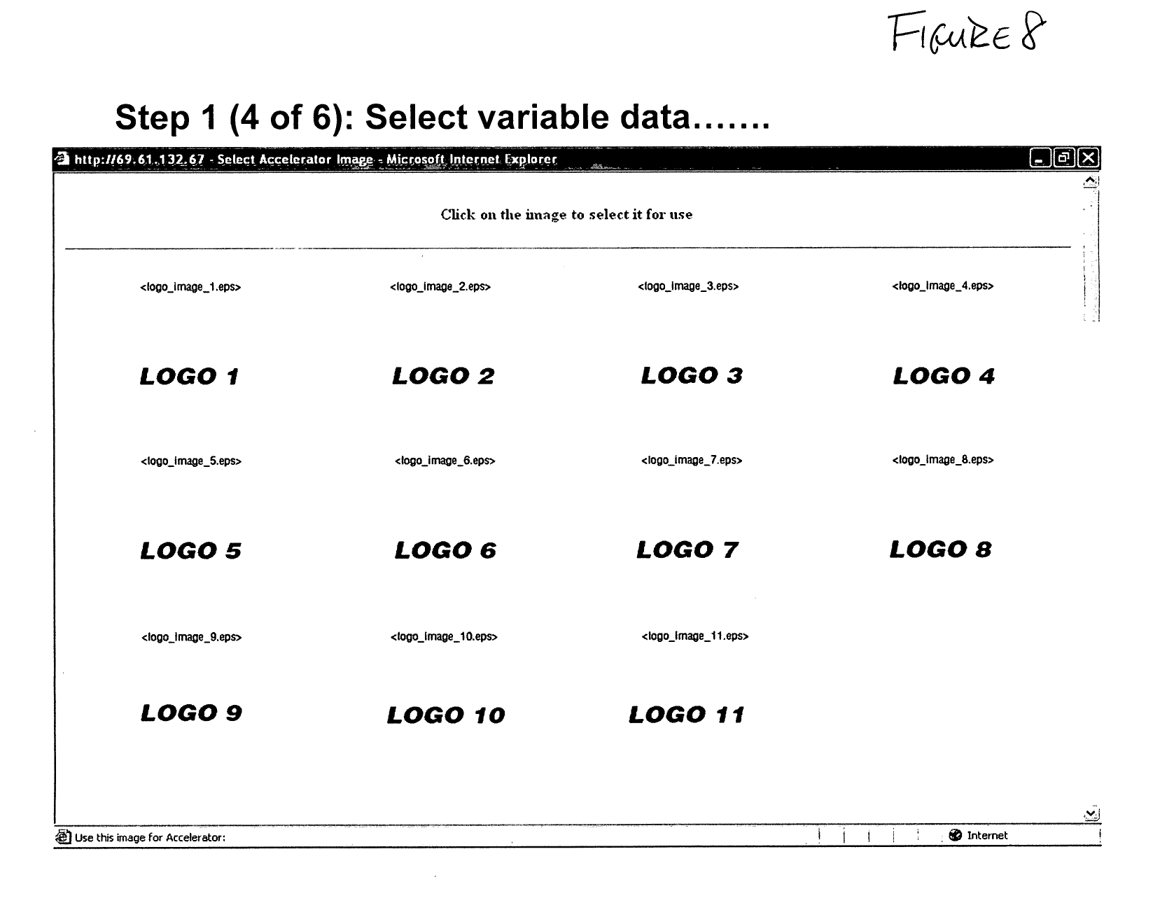

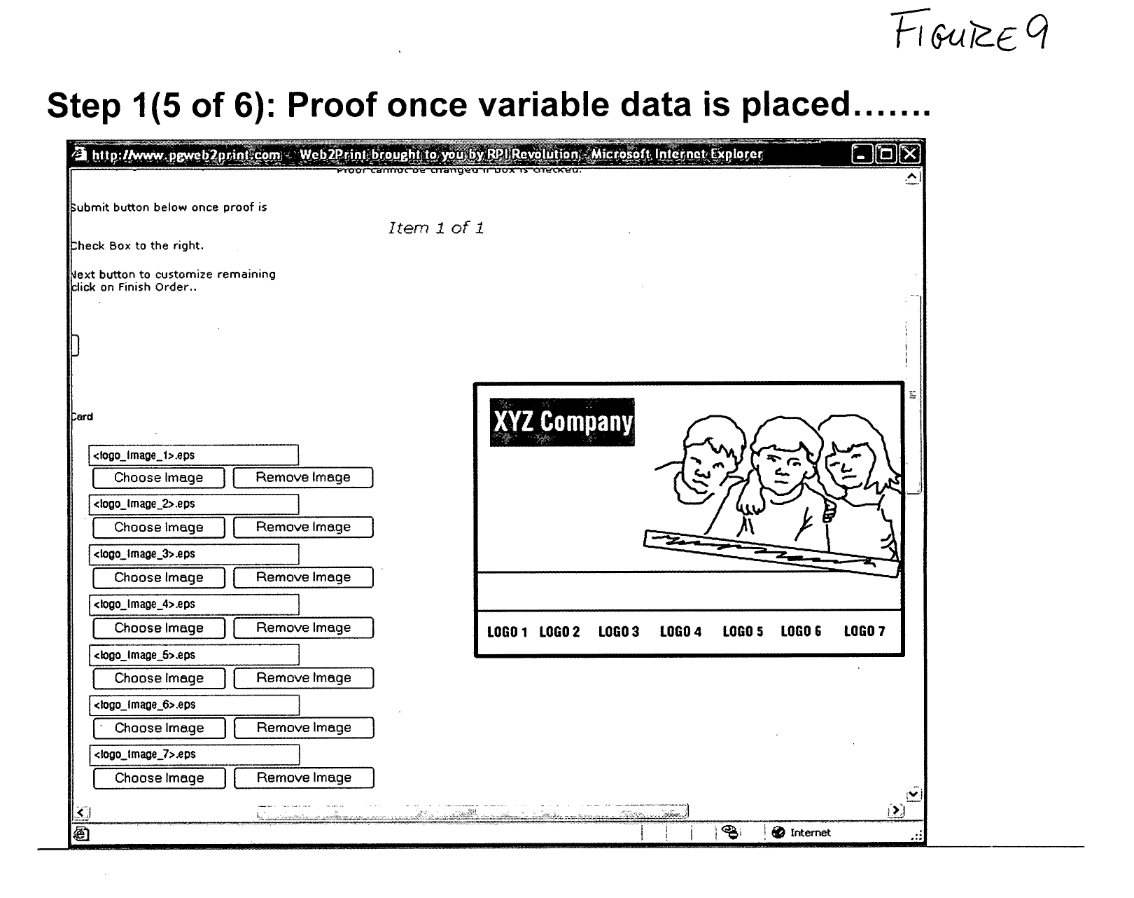

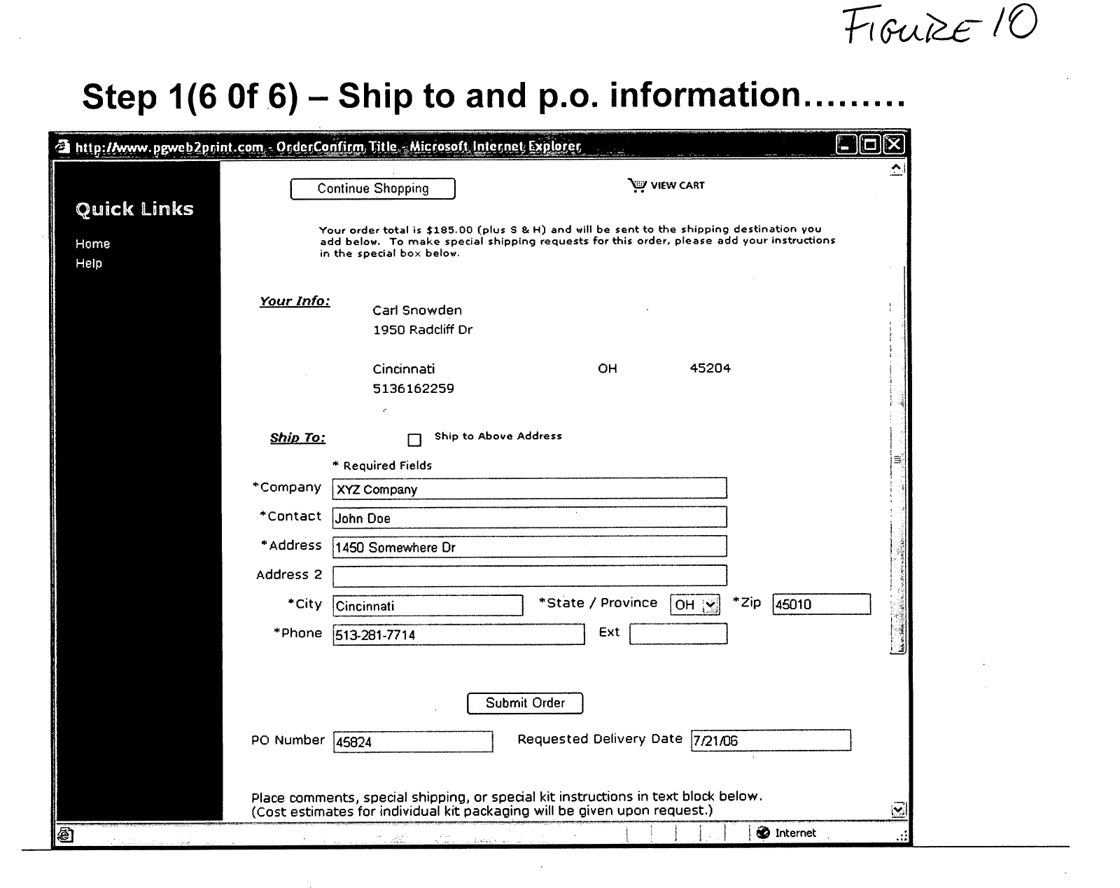

In the present invention, front end meetings and the associated tasks can be eliminated. The customer communicates directly to production, i.e., the printer, via the internet. An example of this process is provided in FIGS. 5-10. The customer, which can be a regional manager, field sales representative, retailer, etc., enters a website, preferably a pass word protected website. See FIG. 5. Once in the website, the customer can select the type of item or items to be printed. See FIG. 6. The items available to be printed can be customized to reflect specific customer or store requirements, such as size, paper, etc. It may also include recommendations on quantity, usage, etc. The customer also selects the desired artwork, such as particular images, logos, or message, and quantity of printed materials desired. See FIGS. 7-8. The customer may also add a customized message prior to printing. A copy of the promotional material, incorporating the customer's choices, is then created for proofing. See FIG. 9. The customer can then input information regarding the shipping instructions for the printed copies. See FIG. 10.

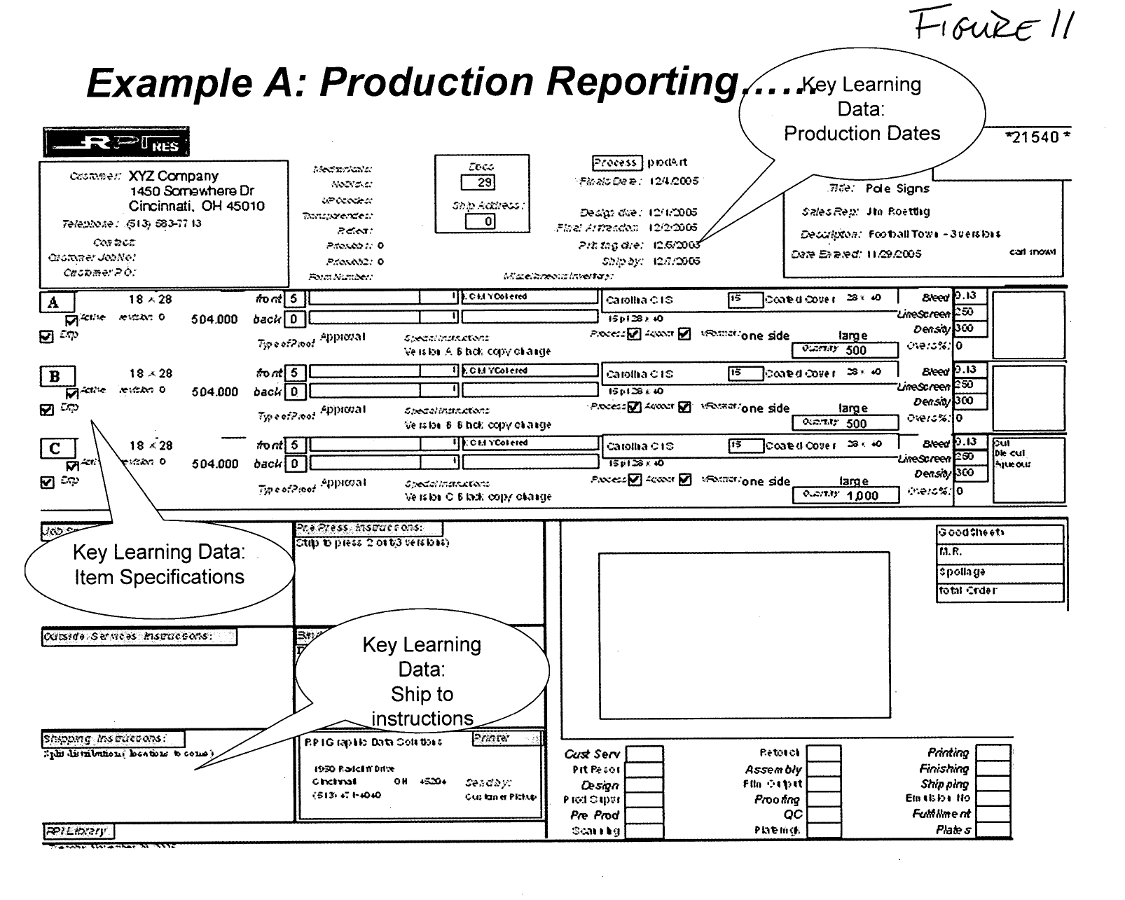

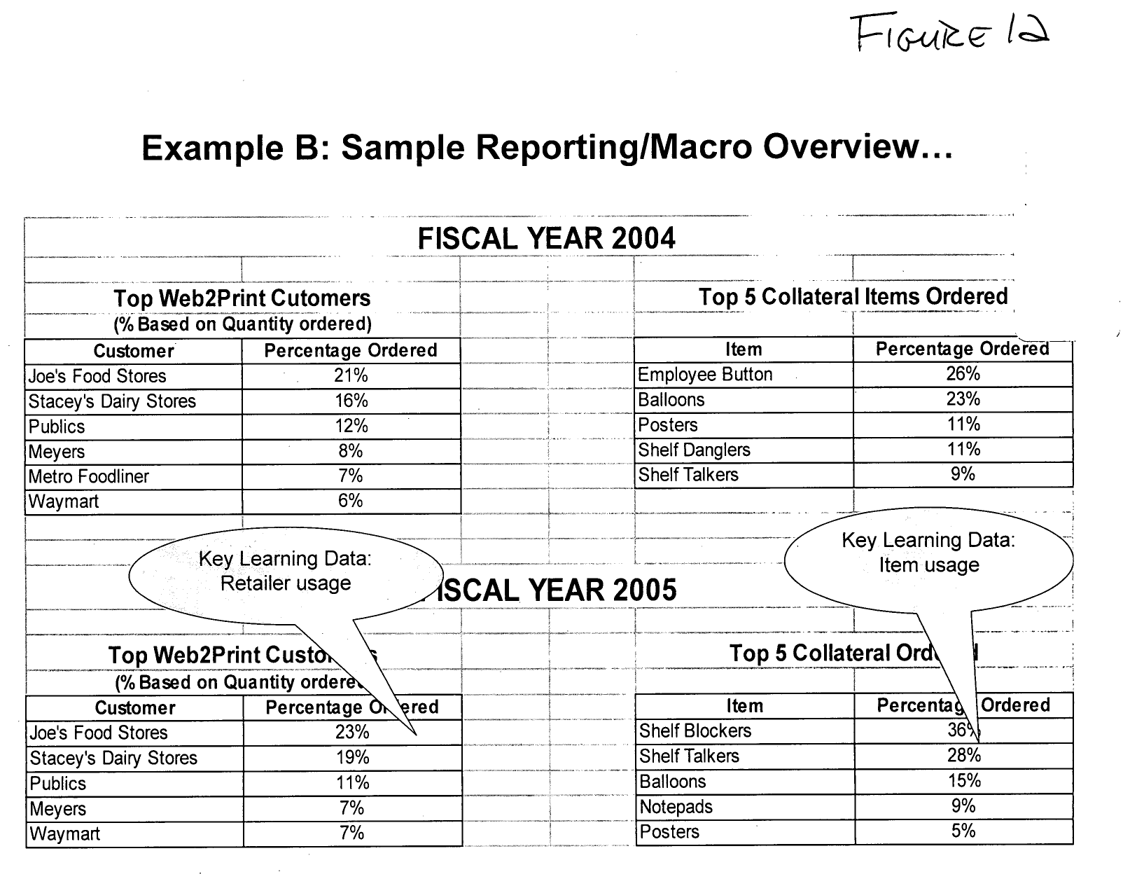

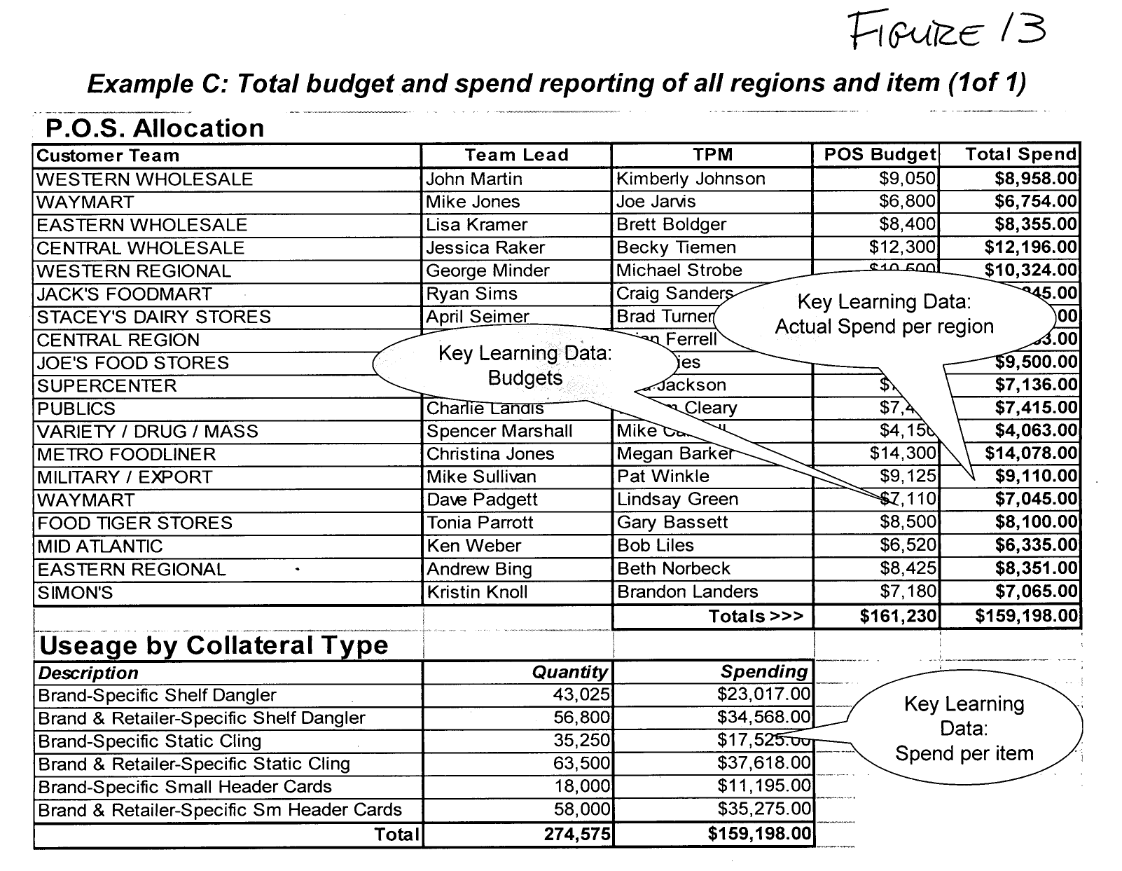

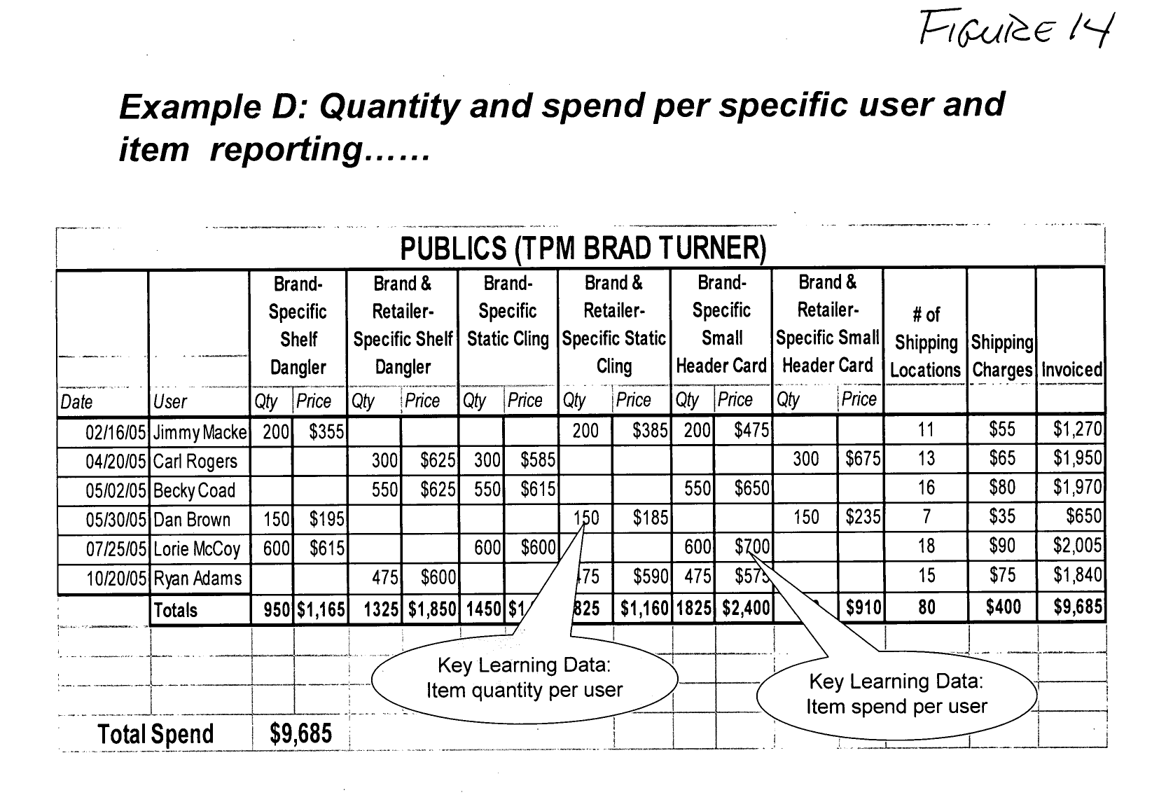

In aspect 2 of the invention, reports can be generated based on the materials requested through the website. See FIGS. 11-14. The reports can be customized or standard reports may be provided to customers. Exemplary reports include production reports, showing among other things quantities of materials ordered. See FIG. 11. Summary information may also be reported, such as total materials by store, by type of item, etc. See FIG. 12. Budgetary reports can also be made available. See FIG. 13. This information allows the brand to control and adjust budgets during a promotional program. FIG. 14 illustrates the type of detailed information, specific to a customer and item, for example, that can be reported.

Developing a website such as that used in the present invention is well-known in the art. Programming necessary to implement the present invention, including the necessary databases, is also well-known. The technique known in the art can be used to develop the website and databases of the present invention.

In one embodiment of the present invention, a user can prepare a marketing calendar and/or promotional schedule that identify the various product promotions throughout the year. A large manufacturer of consumer products might have, during the course of a calendar year, several different promotions for each of its products. These promotions may vary throughout the year and will typically run during specific timeframes. It is important that all advertising copy and promotional materials reflect the proper promotion at the proper time.

Prior to the present invention, this process was usually performed manually. The marketing calendars were divided into separate business units and each assigned an administrator. The administrator updated his or her portion of the calendar almost daily. With each update, the calendar (and, in some instances, any modified promotional materials) was redistributed to the field sales and other brand managers. The sales team and brand managers collected marketing calendars from the several different business unit administrators. This almost daily redistribution resulted in excessive paper consumption, and increased the risk that outdated, or incorrect, promotional materials were used.

With the present invention, users are able to update and change, via the internet, their own marketing schedules which might include these options:
Share coupon schedules to field sales;
Manage coupon redemption values and expiration dates and immediately share any changes to values and/or expiration dates;
View, order, and share upcoming in-store marketing materials for brand maintenance and new product initiatives or launches;
View, order, and share any sales materials for brand maintenance and new product initiatives;
Maintain brand equity with all materials directly provided by brand's preferred design agency from a single-source database;
View all marketing promotions from printed materials to television commercial advertisements timing, schedules.

For instance, if a new product launch is scheduled for a particular month, all individuals involved would have access to view the launch materials and schedules for: in-store promotions, television advertisements, coupon distribution, cross-sell advertisements and promotions (buy Product A and receive a free sample of New Product B), etc.

The method and system of the present invention can use any calendar format to display each promotion on a timeline. With this tool, a user is able to “click” the timeline of a promotion and immediately review supporting promotional materials. The users can choose to order any printed materials directly from the site creating a “print on demand” service.

In other embodiments of the invention, printed materials may be customized to advertise certain price points for a product. Other areas of customization may include advertisements with a desired regional or ethnic influence. Users may also choose to include a specific retailer logo on any collateral materials to generate awareness of where consumers can buy the product. For instance, a user may choose to include a Wal-Mart logo on coupons for use in Wal-Mart stores.

What is claimed is:

1. A method of printing promotional materials comprising the steps of:
(a) making available information necessary to create the desired promotional materials to a customer via a website;
(b) allowing said customer to select promotional materials based on that information;
(c) printing said selected promotional materials; and
(d) providing said printed materials to said customer.

2. The method of claim 1 further comprising the step of generating reports regarding the promotional materials.

3. A method of coordinating a promotional schedule and marketing materials comprising the steps of:
a. providing information regarding at least one scheduled promotion via the internet;
b. providing information necessary to create promotional materials via the internet;
c. relating the information regarding the at least one scheduled promotion and the information necessary to create promotional materials;
d. ordering printed copies of the promotional materials via the internet.

4. The method of claim 2 wherein the information necessary to create promotional materials is selected from the group consisting of approved art work, customer specifications and requirements, pricing information, and combinations thereof.
